(19) United States
(12) Patent Application Publication
(10) Pub. No.: US 2010/0122517 A1
(43) Pub. Date: May 20, 2010

(54) UHMWPE FIBER AND PROCESS FOR PRODUCING THEREOF

(76) Inventors: Joseph Arnold Paul Maria Simmelink, Cadier En Keer (NL); Roelof Marissen, Born (NL); Victor Litvinov, Beek (NL)

Correspondence Address: NIXON & VANDERHYE, PC, 901 NORTH GLEBE ROAD, 11TH FLOOR, ARLINGTON, VA, 22203, US

(21) Appl. No.: 12/598,295

(22) PCT Filed: Apr. 25, 2008
(86) PCT No.: PCT/EP08/03360

§ 371 Date: Oct. 30, 2009

(30) Foreign Application Priority Data
May 1, 2007 (EP) 07008775.4

(51) Int. Cl. D02G 3/02; C08F 110/02

(52) U.S. Cl. 57/200; 526/352

(57) ABSTRACT

The invention relates to gel-spun ultra high molecular weight polyethylene (UHMWPE) fibers and to a process for producing thereof. Specifically, the invention relates a gel-spun UHMWPE fiber comprising an UHMWPE having an intrinsic viscosity in decaline at 135° C. of at least 8 dl/g, and having a T₁ relaxation time as measured by Solid-State proton NMR at 26° C. of at least 600 ms. The invention further relates to ropes, nets and composites, in particular composites for ballistic applications containing the UHMWPE fibers of the invention.

The invention relates to gel-spun ultra high molecular weight polyethylene (UHMWPE) fibers and to a process for producing thereof. The invention further relates to ropes, nets and composites, in particular composites for ballistic applications containing the UHMWPE fibers.

Gel-spun UHMWPE fibers are prepared by spinning into filaments a solution of UHMWPE, cooling the fluid filaments to a gel state and then removing the spinning solvent to form solid filaments. One or more of the fluid, gel or solid filaments are drawn to a state wherein the UHMWPE molecules within the filaments are highly oriented. The UHMWPE fibers and the gel-spinning process of obtaining thereof are described for instance in EP 1,137,828 B1; WO 2005/066,401; EP 1,193,335; U.S. Pat. No. 6,958,187; and U.S. Pat. No. 6,969,553.

Although gel-spinning processes tend to produce highly oriented UHMWPE fibers, defects often occur in the overall molecular structure of said fibers, in particular in the crystalline fraction of said molecular structure. Such defects as for example chain-folds, loops, entanglements and kinks in the zig-zag UHMWPE molecules have detrimental effects on fibers' physical and mechanical properties.

It is expected that UHMWPE fibers having an overall molecular structure containing fewer defects and in particular UHMWPE fibers having an increased perfection of their crystalline fraction as in single crystals, exhibit superior performance in various applications as for example composites, ropes and nets.

Hence, a need exists for gel-spun UHMWPE fibers having an increased perfection of their overall molecular structure and in particular for gel-spun UHMWPE fibers comprising a crystalline UHMWPE fraction having a structure that is closer to the structure of an ideal UHMWPE crystal.

It is therefore an objective of the invention to provide an UHMWPE fiber with an increased perfection of its overall molecular structure, i.e. a molecular structure containing fewer defects than the overall molecular structure of the known UHMWPE fibers and also a method of producing such fibers. A further objective of the invention is to provide an UHMWPE fiber which, additionally to the increased perfection of its overall molecular structure, comprises a crystalline UHMWPE fraction having fewer defects than the crystalline fraction of known UHMWPE fibers and therefore being closer to the structure of an ideal UHMWPE crystal.

The aim is achieved with a gel-spun UHMWPE fiber comprising an UHMWPE having an intrinsic viscosity in decaline at 135° C. of at least 8 dl/g, and having a T₁ relaxation time as measured by Solid-State proton NMR at 26° C. of at least 600 ms.

The perfection of the overall molecular structure of the UHMWPE fiber in accordance with the invention was ascertained by Solid-State proton Nuclear Magnetic Resonance (NMR) by measuring the spin-lattice T₁ relaxation time, hereinbefore and after referred to as the “T₁ relaxation time”, characteristic to said UHMWPE fiber. The T₁ relaxation time is determined from an inversion recovery experiment as explained later herein. The T₁ relaxation time depends on the total number of defects, as for example those afore mentioned, present in the overall molecular structure of the UHMWPE fiber, its value increasing with improving the perfection of said molecular structure, i.e. a molecular structure presenting less defects.

Surprisingly it was found that for the UHMWPE fiber of the invention, the T₁ relaxation time is larger then the T₁ relaxation time of the known UHMWPE fibers, hence, the overall molecular structure of the UHMWPE fibers of the invention contains fewer defects and therefore being more perfect.

Preferably, the T₁ relaxation time of the UHMWPE fibers of the invention is at least 700 ms, more preferably at least 800 ms, even more preferably at least 900 ms, yet even more preferably at least 1000 ms, most preferably at least 1100 ms.

The inventors found that the UHMWPE fibers of the invention having an increased perfection of their overall molecular structure, show improved physical properties or improved combination of physical properties as for example an improved dimensional stability, a very low moisture or water absorption and a high retention of their tensile strength in wet conditions.

The inventors further found that the UHMWPE fibers of the invention show increased tensile properties when compared to equally stretched known fibers. Without being bound by any theory, the inventors attributed the increase in tensile properties to the combination between the increased perfection of the overall molecular structure of the UHMWPE fibers of the invention and the potential of UHMWPE with an IV higher than 8 dl/g to form high strength fibers due to, for example, a high strength carbon-carbon bond, a long and regular chain having a small cross-sectional area and a capability of close molecular packing yielding a high crystallinity.

The tensile strength of the UHMWPE fiber according to the invention is preferably at least 2.5, more preferably at least 3 GPa, even more preferably at least 3.5 GPa, yet even more preferably at least 4 GPa, yet even more preferably at least 4.5 GPa, most preferably at least 5 GPa.

For simplicity, the UHMWPE fibers having a tensile strength of at least 2.5 GPa are hereinafter referred to as high strength UHMWPE fibers.

In a preferred embodiment, the UHMWPE fiber of the invention has a spin-spin T₂ relaxation time, hereinafter referred to as the T₂ relaxation time, as measured by Solid-State proton NMR at 26° C. of at most 10.3 μs. More preferably, the T₂ relaxation time of the UHMWPE fiber of the invention is at most 10.2 μs, even more preferably at most 10.1 μs, yet even more preferably at most 10 μs, yet even more preferably at most 9.9 μs, yet even more preferably at most 9.8 μs, yet even more preferably at most 9.7 μs, most preferably at most 9.6 μs.

The T₂ relaxation time is a measure of the perfection of the UHMWPE fiber's crystalline fraction and it depends on the number of defects present in the crystalline fraction of said fiber, as for example those enumerated hereinabove, its value decreasing with improving the perfection of said crystalline fraction. The T₂ relaxation time characteristic to said UHMWPE fiber was ascertained by Solid-State proton NMR being extracted from a decay of a proton transverse magnetization, hereafter called free induction decay (FID), of the UHMWPE fiber, said decay being recorded using the referred technique.

It was surprisingly found that the UHMWPE fibers of the invention having an improved perfection of their overall molecular structure and comprising a crystalline fraction having a structure that is closer to the structure of UHMWPE crystals show improved behavior under shock loading, i.e. improved resilience when subjected to fast mechanical loads. The improved shock loading behavior is mainly advantageous when said fibres are used in applications where they have to cope with fast mechanical loads generated during impact with fast moving objects.

The UHMWPE fibers of the invention are suitable for a wide variety of applications. For example, said UHMWPE fibers may be used in the manufacturing of kite lines, dental floss, medical devices e.g. sutures, implants and prosthetic devices, tennis racquet strings, canvas e.g. tent canvas, nonwoven cloths and other types of fabrics, webbings, battery separators, capacitors, pressure vessels, hoses, automotive equipment, power transmission belts, building construction materials, helicopter seats, spall shields, protective gloves, composite sports equipment such as skis, helmets, kayaks, canoes, bicycles and boat hulls and spars, speaker cones, high performance electrical insulation, radomes and the like.

In particular, the invention relates to composite articles comprising the UHMWPE fibers of the invention. The advantage of such composite articles is that a lower amount of said UHMWPE fibers can be utilized to obtain a composite article having the same mechanical characteristics (e.g. mechanical strength and impact energy absorption) as a composite article comprising known UHMWPE fibers and/or that the same amount of said UHMWPE fibers can be utilized to obtain a composite article having improved mechanical characteristics as a composite comprising known UHMWPE fibers.

In a particular embodiment, said composites comprising the UHMWPE fibers of the invention are used in ballistic applications, e.g. body armor, helmets, shield panels and the like, as such products show lower weight while retaining their protective performance. Therefore, the invention further relates to ballistic articles and also to cut and stab resistant and incision resistant articles, comprising the UHMWPE fibers of the invention.

Preferably, said articles comprise UHMWPE fibers of the invention, said fibers having a tensile strength of at least 3.5 GPa, more preferably at least 4 GPa, most preferably at least 4.5 GPa.

In a preferred embodiment, said articles comprise the UHMWPE fibers of the invention having a T₁ relaxation time of at least 780 ms, a T₂ relaxation time of at most 9.95 μs and a tensile strength of at least 3 GPa. Preferably, the tensile strength is at least 3.5 GPa, more preferably at least 4 GPa, most preferably at least 4.5 GPa.

The improved physical properties or improved combination of physical properties referred above, make said UHMWPE fibres highly suitable for constructing a variety of ropes for industrial or consumer use, as for example ropes used in the marine industry, e.g. tethers, hawsers, yacht ropes, and the like, speleological and mountaineering ropes, various ropes for agricultural use and various ropes for civil engineering, electric facilities or construction works.

It was moreover found that the UHMWPE fibers of the invention, in particular the high strength UHMWPE fibers of the invention, are especially suitable for applications designed for harsh environments as for example humid and corrosive environments.

Therefore, the invention also relates to ropes comprising the UHMWPE fibers of the invention and the use of said ropes for example in relation to marine vessels and marine industries. In a preferred embodiment concerning such applications, the high strength UHMWPE fibers of the invention are used.

The invention also relates to nets comprising a plurality of interconnected ropes or straps arranged in a lattice structure, said ropes or straps comprising the UHMWPE fibers of the invention, and in particular the high strength UHMWPE fibers of the invention. In a particular embodiment, the nets are used in marine applications, for example as a fishing net or a net for fish farming.

Because the usual marine ropes and nets are constructed of materials such as nylon, polyester, aramids and steel, they have a greatly increased weight and are subject to hydrolytic or corrosive attack by sea water, and furthermore, they have to be replaced regularly to meet various safety factors. The ropes, cables and nets products comprising the UHMWPE fibres of the invention and in particular the high strength UHMWPE fibers of the invention, show a good dimensional and environmental stability as well as increased retention of their mechanical properties, and therefore presenting a longer life time with less maintenance needed. Combined with a very low moisture or water absorption, said products offer significant advantages when employed in marine applications.

The UHMWPE fibers having an increased perfection of their overall molecular structure in accordance with the invention are produced with a new process comprising the steps of:
a) making a 1-30 mass % solution of UHMWPE in a solvent, wherein the UHMWPE has an intrinsic viscosity as measured on solutions in decaline at 135° C. of at least 8 dl/g;
b) spinning the solution through a spinneret having multiple outlets into a fluid stretching zone to form fluid fibers while applying a stretch ratio Δₒ in said outlets of at least 2;
c) stretching said fluid fibers in the fluid stretching zone at a stretch ratio Δ_{fluid} of at least 5 provided that the total stretch ratio of the UHMWPE solution Δₛₒₗᵤₜᵢₒₙ=Δ_{fluid}×Δₒ is at least 150;
d) cooling the fluid fibers to form solvent-containing gel fibers;
e) stretching said gel fibers in at least one stretching step at a stretch ratio Δ_{gel} of at least 2.5 at a temperature of between 80° C. and 140° C.;
f) extracting partly the solvent from the gel fibers to form solid fibers;
g) stretching the solid fibers in at least one stretching step at a stretch ratio Δ_{solid} of at least 4; and
h) removing the remaining solvent during and/or after stretching said solid fibers.

Stretching the gel fibers to increased Δ_{gel} ratios is a new and critical step in the process of manufacturing the UHMWPE fibers of the invention. The gel fibers are preferably stretched in at least one stretching step at a stretch ratio Δ_{gel} of preferably at least 3, more preferably at least 3.5, most preferably at least 4. Preferably, Δ_{gel} does not exceed 10, more preferably 7.5, most preferably Δ_{gel} does not exceed 5. The stretching temperature of the gel fibers is preferably between 100° C. and 130° C.

As used herein, the term “gel fiber” refers to a fiber which upon cooling below the gelation temperature develops a continuous UHMWPE network swollen with the spinning solvent. A visual indication of the conversion of the fluid fiber into the gel fiber and the formation of the continuous UHMWPE network is the change in fiber's transparency upon cooling from a translucent UHMWPE fiber, to a substantially opaque fiber, i.e. the gel fiber.

Due to the combined stretching of fluid and gel fibers during the process of the invention, the overall molecular structure of the UHMWPE fibers is improved resulting also in less frequent filament breakage during the process and therefore making the process of producing said fibers more effective and economical.

By fiber is herein understood an elongated body having a length much greater than its transverse dimensions of width and thickness. Accordingly, the term “fiber” as used herein includes a plurality of filaments, ribbons, strips, threads and the like having regular or irregular cross-sections in continuous or discontinuous lengths. Within the context of the invention a yarn is understood to be an elongate body comprising fibers. The yarn according to the invention may be a twisted or a braided yarn.

The process of the invention uses an UHMWPE having an intrinsic viscosity (IV), as measured on solution in decaline at 135° C. of preferably at least 10 dl/g, more preferably at least 12 dl/g, even more preferably at least 15 dl/g. Preferably, the IV is at most 40 dl/g, more preferably at most 30 dl/g, even more preferably at most 28 dl/g, yet even more preferably at most 25 dl/g.

Preferably, the UHMWPE is a linear polyethylene with less than one side chain per 5.000 carbon atoms, more preferably with less than one side chain per 10.000 carbon atoms, even more preferably with less than one side chain per 15.000 carbon atoms, most preferably with less than one side chain per 20.000 carbon atoms, wherein the side chain preferably contains at most 10 carbon atoms.

In a preferred embodiment, the side chains are C1-C4 alkyl groups, i.e. relatively small alkyl groups having between one and four carbon atoms. It was found that for said side chains the T₂ relaxation time of the UHMWPE fiber of the invention decreased, hence the perfection of the crystalline fraction was improved. It is more preferably that the UHMWPE contains methyl or ethyl side chains, even more preferably methyl side chains.

In the most preferred embodiment, the UHMWPE is a linear polyethylene with less than one side chain per 5.000 carbon atoms and containing methyl or ethyl groups as side chains.

Moreover, the UHMWPE can be a single polymer grade, but also a mixture of two or more different grades, e.g. differing in IV and/or number and/or length of side chains.

The UHMWPE that is applied in the process according to the invention may further contain small amounts, preferably at most 5 mass % of customary additives, as for example anti-oxidants, viscosity modifiers, ultraviolet light stabilizers, fillers, delusterants, thermal stabilizers, colorants, flow promoters, flame retardants, and the like.

In the process according to the invention any of the known solvents suitable for gel spinning of UHMWPE may be used, hereinafter said solvents being referred to for simplicity as spinning solvents. Suitable examples of spinning solvents include aliphatic and alicyclic hydrocarbons such as octane, nonane, decane and paraffins, including isomers thereof; petroleum fractions; mineral oil; kerosene; aromatic hydrocarbons such as toluene, xylene, and naphthalene, including hydrogenated derivatives thereof such as decaline and tetralin; halogenated hydrocarbons such as monochlorobenzene; and cycloalkanes or cycloalkenes such as careen, fluorine, camphene, menthane, dipentene, naphthalene, acenaphtalene, methylcyclopentandien, tricyclodecane, 1,2,4,5-tetramethyl-1,4-cyclohexadiene, fluorenone, naphtindane, tetramethyl-p-benzodiquinone, ethylfuorene, fluoranthene and naphthenone. Also combinations of the above-enumerated spinning solvents may be used for gel spinning of UHMWPE, the combination of solvents being also referred to for simplicity as spinning solvent. It is found that the present process is especially advantageous for relatively volatile solvents, like decaline, tetralin and several kerosene grades. In the most preferred embodiment the solvent of choice is decaline.

The solution of UHMWPE in the spinning solvent may be made using known methods. Preferably, a twin-screw extruder is utilized to make a homogeneous solution starting from an UHMWPE/solvent slurry. Preferably, the concentration of the

UHMWPE solution is between 3 and 20 mass %, with a lower concentration being preferred the higher the molar mass of the UHMWPE is.

The UHMWPE solution may be delivered to an extruder, which extrudes said UHMWPE solution, preferably at constant flow rate, through a spinneret to form fluid fibers. The temperature of the extruded UHMWPE solution, hereinafter referred to as the spinning temperature, depends on the spinning solvent used to form the UHMWPE solution and is preferably in the range from about 150° C. to about 280° C.

The spinneret used in the process according to the invention has multiple outlets. Preferably, the spinneret contains at least 10 outlets, more preferably at least 30 outlets, even more preferably at least 60 outlets, even more preferably at least 90 outlets, most preferably at least 120 outlets.

The outlets of the present invention have a geometry in length and transverse directions which imposes a stretch ratio Δₒ to the UHMWPE solution in the outlets of at least 2. Therefore, a partial orientation of the UHMWPE molecules is achieved during spinning the UHMWPE solution through the outlets. The stretch ratio in the outlet Δₒ equals the ratio between the average speeds of the UHMWPE solution flow at the initial and final cross-sections of the outlets which equals the ratio of the respective cross-sections' area.

In a preferred embodiment, the outlet has a geometry comprising at least one constriction section, i.e. a section with a gradual decrease from an initial diameter d₀ to a final diameter d_{f} that is smaller than d₀, the constriction section preferably having a length L_{cs} of at least 0.15 cm, more preferably of at least 0.3 cm, even more preferably of at least 0.5 cm. It is preferred that L_{cs} is at most 4 cm, more preferably at most 2 cm, even more preferably at most 1 cm. Within the context of the present invention the diameter of an outlet is meant to be the effective diameter; that is for non-circular or irregularly shaped outlets the largest distance between the outer boundaries.

In a further preferred embodiment, the constriction section is followed by a section of constant diameter d_{f} and of length L_{f} having a length/diameter ratio L_{f}/d_{f} of from 0 to at most 25. Preferably, the length/diameter ratio L_{f}/d_{f} is at most 20, more preferably at most 15, even more preferably at most 10, most preferably at most 5.

In an even further preferred embodiment, the outlet consists of more than one constriction sections, each constriction section being preferably followed by a section of constant diameter.

Yet in an even further preferred embodiment, the outlets have a circular cross-section, in this case the stretch ratio in the outlets amounting the ratio between the square of the initial and final diameter of the outlets, that is Δₒ=(dₒ/d_{f})². The final diameter d_{f} of the spinhole may vary, depending on total stretch ratio and desired fiber thickness. Preferably, d_{f} is between 0.2 and 5 mm, more preferably between 0.3 and 2 mm.

Preferably, the stretch ratio Δₒ achieved in the outlet is at least 5, more preferably at least 10, even more preferably at least 15, yet even more preferably at least 25, most preferably a stretch ratio of at least 40 is achieved in the outlets.

As used herein, the term “fluid fiber” refers to fibers containing a solution of UHMWPE in a spinning solvent. Most often, the concentration of the UHMWPE in the extruded fluid fibers is the same or about the same with the initial concentration of the UHMWPE solution.

The fluid fibers formed by spinning the solution through the spinneret are extruded into a zone hereinafter referred to as a fluid stretching zone, and then into a cooling zone from where they are picked-up on a first driven roller. By fluid stretching zone is herein understood the zone traversed by the fluid fibers between the spinneret's exit and the beginning of the region where the cooling process of the fluid fibers takes place.

In accordance with the invention, the fluid fibers are stretched in the fluid stretching zone by choosing an angular speed of the first driven roller such that the said roller's surface velocity exceeds the flow rate of the UHMWPE solution issued form the spinneret.

The stretch ratio in the fluid stretching zone, Δ_{fluid}, is at least 5, preferably at least 10, more preferably at least 20, most preferably at least 50. The combination Δₒ and Δ_{fluid} is chosen such to yield a total stretch ratio of the UHMWPE solution Δₛₒₗᵤₜᵢₒₙ of at least 150, preferably at least 200, more preferably at least 250, even more preferably at least 300, yet even more preferably at least 400, most preferably at least 500.

Such a high total stretch ratio Δₛₒₗᵤₜᵢₒₙ of the UHMWPE solution has the advantage that high strength UHMWPE fibers having an increased perfection of their overall molecular structure are obtained.

Preferably, the fluid stretching zone has a length of at least 3 mm, more preferably at least 10 mm, even more preferably at least 25 mm. Preferably, the fluid stretching zone has a length of at most 100 mm, more preferably at most 75 mm, even more preferably at most 50 mm.

The atmosphere in the fluid stretching zone may be air or an inert gas as for example nitrogen or argon and may also contain vapors of the spinning solvent.

From the fluid stretching zone the fluid fibers pass into a cooling zone to form solvent—containing gel fibers, wherein said fluid fibers are cooled in the cooling zone below a temperature hereinafter referred to as the gelation temperature, whereat the solubility of the UHMWPE is much less than the initial concentration of the UHMWPE solution.

In one embodiment, the cooling of the fluid fibers in the cooling zone is carried out by using a gas flow. It is preferred that in the cooling zone a temperature gradient exists, the temperature dropping in the cooling zone from about the spinning temperature to at most 100° C., more preferably to at most 80° C., even more preferably to at most 60° C. Preferably, a gas flow is present in said cooling zone, said gas flow preferably being in a turbulent state in order to achieve an effective heat transmission between the yarn and the cooling gas. Preferably, the gas circulation in the cooling zone has a time-average gas velocity in the vicinity of the fluid fibers from 1 to 100 meters/minute, more preferably from 2 to 80 meters/minute, most preferably from 5 to 60 meters/minute.

Preferably, the cooling gas is identical with the gas used to create the atmosphere in the fluid stretching zone, e.g. nitrogen or other inert gas, in order to prevent the formation of an explosive mixture of gas and spinning solvent vapors.

In a preferred embodiment, the cooling gas is saturated with water vapors assuring an even more effective heat transmission between the fluid fibers and the cooling gas. In an even more preferred embodiment, the mixture also contains vapors of the spinning solvent.

In another embodiment, a liquid cooling bath is used to cool down the fluid fibers, the advantage being that the stretching conditions are better definable and controllable. Preferably, the fibers are quenched in a cooling bath containing a cooling liquid, which cooling liquid is not miscible with the spinning solvent, the temperature of the cooling liquid being controlled and a flow of the cooling liquid preferably being provided across the fibers at least at the location where the fluid fibers enter the cooling bath. More preferably, the cooling bath comprises a mixture of the spinning solvent used to prepare the UHMWPE solution and the cooling liquid.

Cooling of the fluid fibers into solvent-containing gel fibers may be also performed with a combination of a gas flow cooling and a liquid cooling bath.

Subsequently to stretching the gel fibers, the spinning solvent from the gel fibers is partly extracted to form fibers hereinafter referred to as solid fibers. Preferably, after the extraction step the solid fiber contains spinning solvent in an amount of at most 15% by total weight of the fiber, more preferably in an amount of at most 10%, most preferably the solid fiber contains spinning solvent in an amount of at most 5% by total weight of the fiber.

The solvent extraction process may be performed by known methods, for example by evaporation when a volatile or relatively volatile spinning solvent is used to prepare the UHMWPE solution or by using an extraction liquid or by a combination of all enumerated methods. Suitable extraction liquids are liquids that do not cause significant changes in the structure of the UHMWPE gel fibers, for example ethanol, ether, acetone, cyclohexanone, 2-methylpentanone, n-hexane, dichloromethane, trichlorotrifluoroethane, diethyl ether and dioxane or a mixture thereof. Preferably, the extraction liquid is chosen such that the spinning solvent can be separated from the extraction liquid for recycling.

In a preferred embodiment, before the extraction step, part of the solvent is removed by resting the gel fibers in a container for a time, hereinafter referred to as the dwell time, varying from several minutes to days. Preferably, the dwell time is at least 10 minutes, more preferably at least 30 minutes, most preferably at least 60 minutes. The maximum dwell time is preferably at most 5 days, more preferably at most 2 days, most preferably at most 1 day.

Extraction times may vary widely and are chosen such that a desired amount of the spinning solvent is extracted. Usually extraction times will vary from a few minutes or seconds up to hours or days. Preferred extraction times are from about 30 seconds to about 24 hours, more preferred extraction times being from about 30 seconds to about 10 minutes.

Extraction temperatures may vary widely depending on a number of factors, in particular the volatility of the spinning solvent or the solubility of the spinning solvent in the extraction liquid at a given temperature. When an extraction liquid is used it is preferred that the extraction step is carried out at ambient temperature, i.e. from about 20° C. to about 30° C.

The process of producing the UHMWPE fiber of the invention further comprises, in addition to stretching the fluid and the gel fibers, stretching the solid fibers in at least one stretching step with a stretch ration Δ_{solid}, hereinafter referred to as the solid stretch ratio, of at least 4. More preferably, the solid stretch ratio is at least 8, even more preferably, the solid stretch ratio is at least 12. Stretching the solid fibers to such high solid stretch ratios proved beneficial for improving the perfection of the crystalline fraction of the overall molecular structure.

The stretching of the solid fibers, preferably takes place at temperatures between about 110 and about 160° C., more preferably between about 120 and about 160° C., most preferably between about 125° C. and about 155° C.

In a preferred embodiment, stretching of the solid fibers is performed in more than two steps, and preferably at different temperatures with an increasing profile between about 120 and about 155° C.

In an even more preferred embodiment, a 3-step stretching process is applied on solid fibers the total stretch ratio of the solid fibers Δ_{solid} being Δ_{solid}=Δ_{solid 1}*Δ_{solid 2}*Δ_{solid 3}; i.e. the total stretch ratio applied on solid fibers is the product of the stretch ratios applied in each of the stretching steps. The advantage of using a 3-step stretching process to stretch the solid fibers is that the tensile strength of the UHMWPE fibers is further increased while the process of producing said fiber is further stabilized, i.e. less breakage of filaments.

Solvent removal takes place during and/or after stretching the solid fibers.

Preferably, the solvent is removed such that the UHMWPE fiber of the invention at the end of the manufacturing process contains at most 2% by fiber weight of spinning solvent, preferably at most 10%, more preferably at most 5% by fiber weight of spinning solvent. Yet even more preferably, the fibers contain at most 2000 ppm of spinning solvent, most preferably at most 1000 ppm of spinning solvent.

The solvent may be removed by any processes for solvent removal known in the art as for example, evaporation or removal by subjecting the fiber to a vacuum extraction process.

The process according to the invention may further comprise additional steps known in the art, like for example applying an antistatic agent, spin finish or sizing agent to a yarn comprising the fibers of the invention.

Hereinafter the figures are explained:

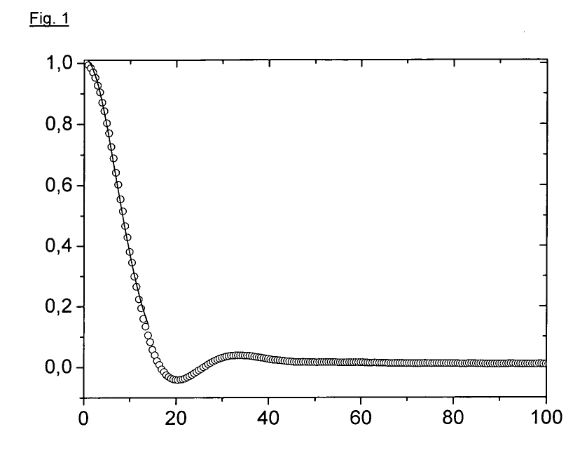

FIG. 1 represents a normalized proton FID (A(t)/A₀ vs. time t in μs) characteristic to an UHMWPE fiber (Comparative Experiment A) as recorded by Solid-State proton NMR. The solid line represents the fitting of the part of the spectrum used to compute the T₂ relaxation time.

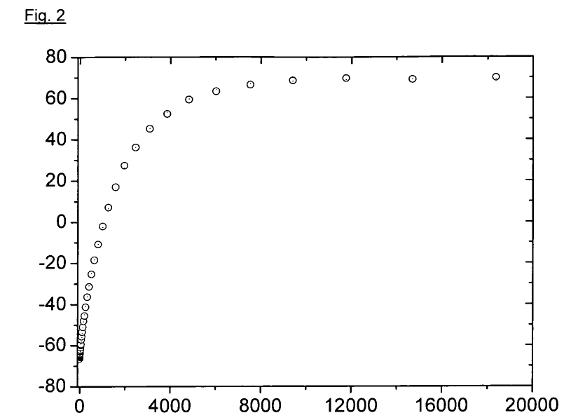

FIG. 2 shows the variation of A(tᵢₙᵥ) (in arbitrary units) as determined with the inversion recovery technique vs. tᵢₙᵥ (in milliseconds) characteristic to an UHMWPE fiber (Example 1) as recorded by Solid-State proton NMR.

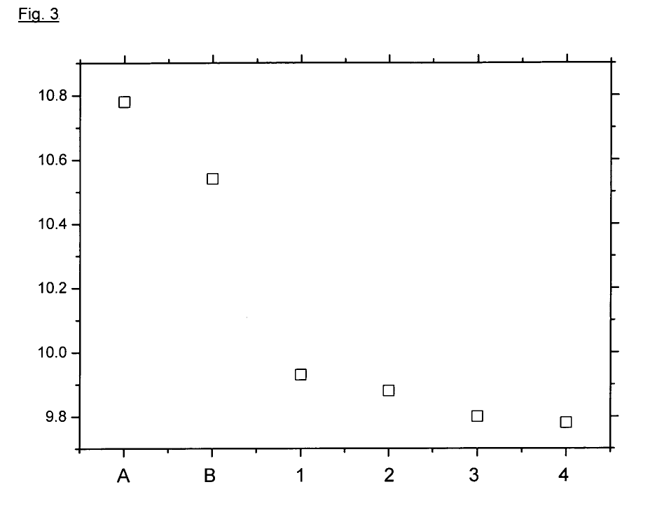

FIG. 3 shows the values of the T₂ relaxation time in μs as determined from the recorded proton FID for the fibers of the Examples and Comparative experiments accompanying the invention

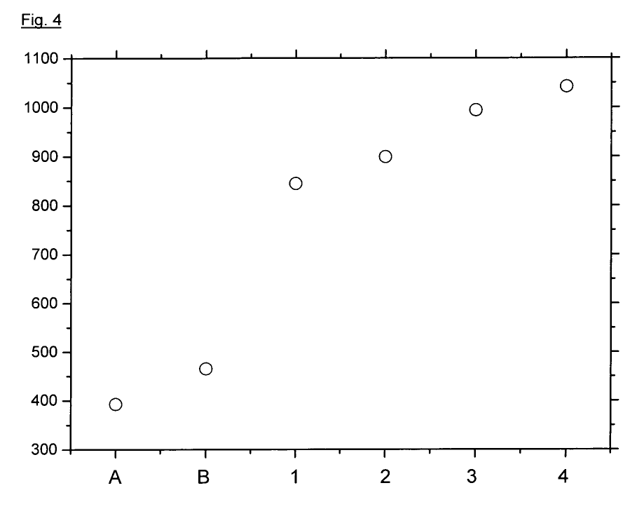

FIG. 4 shows the values of the T₁ relaxation time in ms characteristic to the UHMWPE fibers of the Examples and Comparative experiments accompanying the invention.

The invention is further elucidated by the following examples and comparative experiments.

### Measurements of Intrinsic Viscosity, Amount of Side Chains and Tensile Properties:

IV: the Intrinsic Viscosity is determined according to method PTC-179 (Hercules Inc. Rev. Apr. 29, 1982) at 135° C. in decaline, the dissolution time being 16 hours, with DBPC as anti-oxidant in an amount of 2 g/l solution, by extrapolating the viscosity as measured at different concentrations to zero concentration;
Side chains: the number of side chains in a UHPE sample is determined by FTIR on a 2 mm thick compression moulded film, by quantifying the absorption at 1375 cm⁻¹ using a calibration curve based on NMR measurements (as in e.g. EP 0269151);
Tensile properties: tensile strength (or strength) is defined and determined on multifilament yarns as specified in ASTM D885M, using a nominal gauge length of the fibre of 500 mm, a crosshead speed of 50%/min and Instron 2714 clamps, of type Fibre Grip D5618C. On the basis of the measured stress-strain curve the modulus is determined as the gradient between 0.3 and 1% strain. For calculation of the modulus and strength, the tensile forces measured are divided by the titre, as determined by weighing 10 metres of fibre; values in GPa are calculated assuming a density of 0.97 g/cm³.
Measurements of the T₁ and T₂ relaxation times:
   Solid-State proton NMR relaxation experiments were performed for static samples on a Bruker Minispec MQ-20 spectrometer. The samples were all UHMWPE fibers, said fibers being either produced in accordance with the invention, either produced with alternative processes as in the comparative experiments. The afore-mentioned spectrometer operates at a proton resonance frequency of 19.6 MHz.
   All experiments were performed at 26° C., the temperature being regulated with a BVT-2000 temperature controller having an accuracy of ±0.1° C. The value of the temperature was cross-checked separately for each sample by using a RTD sensor Pt100 having 0.5 mm in diameter.

Single pieces of yarns were cut, about 0.35 grams being packed in a NMR glass tube of 9 mm in diameter. No specific fiber alignment procedure was followed, insuring therefore a random packing of the fibres in the NMR tube without any preferential fiber orientation.

The spin finish applied on fiber's surface was removed for all investigated fibers by washing the fibers in hexane. The samples were thoroughly dried at room temperature in a jet of nitrogen to remove any traces of hexane that might influence NMR measurements.

The T₂ relaxation times characteristic to the investigated UHMWPE fibers were obtained using proton spin-spin relaxation time experiments by recording the time dependence of a magnetisation M_{xy} induced in the sample. M_{xy} is the magnetization in the XY-plane of the sample obtained by turning with 90° a magnetization M_{z} induced by applying along the Z-axis a permanent homogeneous magnetic field Bₒ to the sample. The magnetisation M_{xy} is induced by a radio-frequency electromagnetic pulse, hereinafter called RF pulse, applied to the sample that is already subjected to the homogeneous magnetic field Bₒ. After applying the RF pulse, the amplitude of M_{xy} decays in time, said time being the T₂ relaxation time.

The RF pulse sequence consisted of two individual RF pulses having equal duration and was applied to the UHMWPE fiber while the sample was kept under the permanent homogeneous magnetic field Bₒ. The individual RF pulses were applied under an angle of 90° with respect to Bₒ. The duration of a RF pulse and the dead time of the spectrometer were 2.68 μs and 7 μs, respectively. The dead time of the spectrometer is the time where no NMR signal recording takes place. The dwell time of the spectrometer, i.e. the time between each sampled data points was 0.5 μs.

The RF pulse sequence, also called solid-echo pulse sequence (SEPS), was used to record a proton free induction decay (FID), said SEPS consisting of a sequence of pulses as follows:

90°ₓ−tₛₑ−90°_{y}−(tₛₑ+t₉₀)−[the time needed for the acquisition of the amplitude A(t) of the FID]

wherein 90° corresponds to a RF pulse that turns the macroscopic magnetization vector by 90°, the pulse being applied along both the X- and the Y-axis in a rotating frame, hereinabove the pulses along those axes being defined as 90°ₓ and 90°_{y}, respectively, and wherein tₛₑ is a delay time between the pulses, tₛₑ being set to 10 μs and t₉₀ is the duration of the 90° pulse. The term “rotating frame” is background knowledge in NMR technology being defined for example in the book of T. C. Farrar and E. D. Becker, “Pulse and Fourier Transform NMR. Introduction to Theory and Methods”, Academic Press, New York, 1971, at pages 8-15.

The SEPS technique was used to avoid eventual systematic errors in the subsequent data analysis, having the advantage that it allows avoiding the dead time of the spectrometer. By only using a single 90° pulse excitation technique, the region of the proton FID corresponding to the dead time of the spectrometer cannot be recorded whereas by using the SEPS technique the entire shape of the proton FID is detected, avoiding therefore the dead time of the spectrometer.

The solid-echo has a maximum at approximately t=(2tₛₑ+t₉₀) from the beginning of the first pulse, where t₉₀ is the duration of the 90° pulse. This allows accurate measurement of the shape of the proton FID including its initial part. The proton FIDs were acquired after a time t=(2tₛₑ+t₉₀) from the beginning of the first 90° pulse. In the graphical representation of FIG. 1 the time t=(2tₛₑ+t₉₀) was set to zero, i.e. it was taken as the origin of the time axis.

FIG. 1 shows a normalized proton FID characteristic to a UHMWPE fiber (Comparative Experiment A) as measured by Solid-State proton NMR. The normalization was performed by dividing the amplitude A(t) by the amplitude at t=0 which is A₀. As it can be seen from FIG. 1, the proton FID can be separated in several parts, each part corresponding to a certain mass fraction of the components forming the fiber's morphology.

Specifically referring to the spectrum represented in FIG. 1, the part between 0 and about 40 μs is influenced by defects present in the crystalline fraction of the UHMWPE fiber, whereas the part above 40 μs is influenced by defects present in the overall structure of said fiber. It can be observed from FIG. 1 that the amplitude ratio A(t)/A₀ of the NMR signal decays with more than 90% over a period of about 40 μs, the decaying time being a measure of the perfection of crystalline fraction of the UHMWPE fiber.

More particularly, the decay rate of the amplitude ratio A(t)/A₀ from t=0 to t=16 μs is the part of the proton FID that is most interesting, as this region is a measure of the perfection of the molecular structure of the UHMWPE chains in the UHMWPE fiber. The decay time or the T₂ relaxation time was extracted from this region by fitting the part of the proton FID between 0 and 16 μs with a function of type:

$$A ( t ) = {A}_{0} {e}^{- {( \frac{t}{{T}_{2}} )}^{2}} \qquad Formula 1$$

wherein A(t) is the amplitude at time t and A₀ is the amplitude at t=0.

The number of scans, which were acquired in order to improve the signal-to-noise ratio of the proton FID, was 400, with a recycling delay time between each subsequent acquisition of 20 seconds.

The spin-lattice T₁ relaxation times characteristic to the investigated UHMWPE fibers were obtained using an inversion-recovery technique. The inversion-recovery technique was similar to the technique used to determine the T₂ relaxation time with the exception of the RF pulse sequence and the subsequent data analysis.

The RF pulse sequence for the inversion-recovery technique, hereinafter called the inversion RF pulse sequence, consisted of a sequence of pulses as follows:

180°ₓ−tᵢₙᵥ−90°ₓ−tₛₑ−90°_{y}−tₛₑ−[the time needed for the acquisition of the amplitude A(tᵢₙᵥ) of the maximum solid-echo signal]

wherein 180°ₓ is a RF pulse of 5.6 μs which turns the magnetization M_{z} with 180°, tᵢₙᵥ is an inversion time, and the 90°ₓ and 90°_{y} are two RF pulse which are equivalent to the ones defined hereinabove in the SEPS. tₛₑ is also as defined hereinabove however having a duration of 14 μs.

A series of inversion RF pulse sequences was used to plot the variation of the amplitude A(tᵢₙᵥ) versus tᵢₙᵥ. A(tᵢₙᵥ) was recorded for each inversion RF pulse sequence with a characteristic tᵢₙᵥ in said series The plot is shown in FIG. 2.

Each inversion RF pulse sequence in the series had a fixed tᵢₙᵥ value, said value varying between sequences from 0.5 ms to 20 sec. For each sequence the chosen tᵢₙᵥ value was equal with value of tᵢₙᵥ of the previous sequence multiplied by 1.15.

The dependence of A(tᵢₙᵥ) on tᵢₙᵥ was fitted using a two-exponential function:

$$A ( {t}_{inv} ) = {A}_{1} ( 0 ) \{ 1 - 2 exp [ - \frac{{t}_{inv}}{{T}_{1}^{*}} ] \} + {A}_{2} ( 0 ) \{ 1 - 2 exp [ - \frac{{t}_{inv}}{{T}_{1}^{**}} ] \}$$

wherein A₁(0) and A₂(0) are the amplitudes of the first and the second exponential function, respectively, at tᵢₙᵥ=0.

The T₁ relaxation time was determined as follow:

$${T}_{1} = \frac{1}{f / {T}_{1}^{*} + ( 1 - f ) / {T}_{1}^{**}}$$

$$wherein$$

$$f = \frac{{A}_{1} ( 0 )}{{A}_{1} ( 0 ) + {A}_{2} ( 0 )}$$

Moreover, the NMR measurements on the fibres of the invention and of the comparative experiments and the calculation of T₁ and T₂ relaxation times were performed in accordance with the instruction provided at pages 20-22 of the book “Pulse and Fourier Transform NMR—Introduction to Theory and Methods” by T. C. Farrar and E. D. Becker, 1974, Academic Press New York and London; at pages 26-27 of the book “NMR: Topography, Diffusometry, Relaxometry” by R. Kimmich, Springer 1997, ISBN 3-540-61822-8; and at page 87 of the article of A. M. Kenwright and B. J. Say, Solid State NMR, 7(1996), 85-93, all these publications being included here as reference.

### EXAMPLES 1

A 9 mass % solution of a UHMWPE homopolymer in decaline was made, said UHMWPE having an IV of 20 dl/g as measured on solutions in decaline at 135° C. The UHMWPE solution was extruded with a 25 mm twin screw extruder equipped with a gear-pump at a temperature setting of 180° C. through a spinneret having 64 outlets into an air atmosphere containing also decaline and water vapors with a rate of about 1.5 g/min per hole. The outlets had a circular cross-section and consisted of a gradual decrease in the initial diameter from 3 mm to 1 mm over a length of 0.17 cm and followed by a section of constant diameter with L/D of 10, this specific geometry of the outlets introducing a stretch ratio Δₒ of 9.

From the spinneret the fluid fibers entered a fluid stretching zone of 25 mm and into a water bath, where the fluid fibers were taken-up at such rate that a stretch ratio Δ_{f} of 20 was applied in the air-gap, the Δ_{fluid} being Δ_{fluid}=Δ_{f}*Δₒ=180.

The fluid fibers were cooled in the water bath to form gel fibers, the water bath being kept at about 40° C. and wherein a water flow was being provided with a flow rate of about 50 liters/hour perpendicular to the fibers entering the bath.

From the water bath, the gel fibers were taken-up into an oven at a temperature of 90° C. at such rate that a stretch ratio Δ_{gel} of 4 was applied to the gel fibers and solvent evaporation occurred to form solid fibers. The solid fibers subsequently entered an oven having a temperature gradient from 90 at the entrance in the oven to 130° C. at the exit where were stretched by applying a stretch ratio of about 4.

### EXAMPLES 2

In Example 2 the experiment of Example 1 was repeated, with the difference that a stretch ratio of 5 was applied to the solid fibers.

### EXAMPLE 3

In Example 3 the experiment of Example 1 was repeated, with the difference that a stretch ratio of 6 was applied to the solid fibers.

### EXAMPLE 4

In Example 3 the experiment of Example 1 was repeated, with the difference that a stretch ratio of 7 was applied to the solid fibers.

### Comparative Experiment A

In Comparative Experiment A the experiment of Example 1 was repeated, with the difference that no stretch ratio was applied to the solid fibers.

### Comparative Experiment B

In Comparative Experiment B the experiment of Example 1 was repeated, with the difference that a stretch ratio of 2 was applied to the solid fibers.

From the results achieved in the examples presented hereinbefore and summarized in Table 1, it can be clearly seen that the UHMWPE fibers of the invention have a longer T₁ and a shorter T₂ relaxation time when compared with the fibers of the comparative experiments, and therefore having an improved perfection of their molecular structure. It can be also observed that the UHMWPE fibers of the invention show significant higher tensile strength than the comparative fibers.

TABLE 1

| Sample | T1 (ms) | T2 (μs) | TS (GPa) |
|---|---|---|---|
| Example 1 | 844.7 | 9.93 | 3.3 |
| Example 2 | 898.7 | 9.88 | 3.9 |
| Example 3 | 994.4 | 9.80 | 4.6 |
| Example 4 | 1042.0 | 9.78 | 4.8 |
| Comp. Exp. A | 392.5 | 10.78 | 1.56 |
| Comp. Exp. B | 465.3 | 10.54 | 2.5 |

1. A gel-spun ultra high molecular weight polyethylene (UHMWPE) fiber, characterized in that the UHMWPE fiber comprises an UHMWPE having an intrinsic viscosity in decaline at 135° C. of at least 8 dl/g, and having a T₁ relaxation time as measured by Solid-State proton ¹H NMR at 26° C. of at least 600 ms.

2. The UHMWPE fiber of claim 1 wherein the T₁ relaxation time is at least 800 ms.

3. The UHMWPE fiber of claim 1 wherein the T₁ relaxation time is at least 1000 ms.

4. The UHMWPE fiber of claim 1 having a T₂ relaxation time as measured by Solid-State proton ¹H NMR at 26° C. of at most 9.95 μs.

5. The UHMWPE fiber of claim 1 having a T₂ relaxation time as measured by Solid-State proton ¹H NMR at 26° C. of at most 10.3 μs.

6. The UHMWPE fiber of claim 1 having a T₂ relaxation time as measured by Solid-State proton ¹H NMR at 26° C. of at most 10 μs.

7. The UHMWPE fiber of claim 1 having a T₂ relaxation time as measured by Solid-State proton ¹H NMR at 26° C. of at most 9.8 μs.

8. The UHMWPE fiber of claim 1 wherein the UHMWPE fiber has a tensile strength of at least 3 GPa.

9. The UHMWPE fiber of claim 1 wherein the UHMWPE fiber has a tensile strength of at least 4 GPa.

10. The UHMWPE fiber of claim 1 wherein the UHMWPE fiber has a tensile strength of at least 5 GPa.

11. A composite article comprising the UHMWPE fibers of claim 1.

12. A ballistic article comprising the UHMWPE fibers of claim 1.

13. A rope or a net comprising the UHMWPE fibers of claim 1.
